(19) United States
(12) Patent Application Publication
(10) Pub. No.: US 2026/0146914 A1
(43) Pub. Date: May 28, 2026

(54) HEALTH STATUS ASSESSMENT METHOD FOR BEARING

(71) Applicant: Aktiebolaget SKF, Goteborg (SE)

(72) Inventors: Chao PANG, Shanghai (CN); Kaihuan ZHANG, Hangzhou (CN); Jinshi CUI, Shanghai (CN); Shuo YAO, Shanghai (CN)

(73) Assignee: Aktiebolaget SKF, Goteborg (SE)

(21) Appl. No.: 19/392,286

(22) Filed: Nov. 18, 2025

(30) Foreign Application Priority Data
Nov. 25, 2024 (CN) 202411696781.2

(51) Int. Cl. G01M 13/04; G05B 23/02

(52) U.S. Cl. CPC G01M 13/04; G05B 23/0283

(57) ABSTRACT

Embodiments of the present disclosure provide a health status assessment method for a bearing. The method includes receiving multi-modal data with respect to the bearing and prompt information related to the content of the health assessment of the bearing. The method includes performing feature extraction on the multi-modal data using a first group of agents to generate a set of features regarding the multi-modal data. The method includes performing a health assessment of the bearing based on the set of features regarding the multi-modal data and the prompt information using a second group of agents to generate a plurality of health assessment results regarding the bearing. The method includes processing the plurality of health assessments using a third group of agents to generate a health assessment report regarding the bearing.

### CROSS-REFERENCE TO RELATED APPLICATION

This application is based on and claims priority to Chinese Patent Application No. 202411696781.2, filed on Nov. 25, 2024 in the Chinese Patent Office, the entirety of which is hereby incorporated by reference.

### FIELD

The present disclosure relates to mechanical equipment, and in particular to a health status assessment method for a bearing.

### BACKGROUND

Bearings are an important components in mechanical equipment. The bearing can support the rotating shaft, and when other components move relative to each other on the rotating shaft, the bearing can be used to maintain the center position of the shaft, thereby supporting the rotating body, reducing friction during its movement, and ensuring its rotation accuracy. Generally, bearings include components such as inner rings, outer rings, rolling elements, and cages.

As bearings continue to be used, the bearings may experience defects such as aging and wear. Bearing aging, wear and other defects may be evaluated by manual or bearing diagnosis software. However, there may be a problem of cost prohibitions for the health assessment of bearings by hand. Health assessment of bearings by bearing diagnostic software may suffer from the problem that the bearing diagnostic software program have high requirements of format of input data and a single type of diagnostic results and maintenance recommendations for the bearing. Additionally, before using the bearing diagnostic software program, the user may need to prepare the specific types of input data required by the bearing diagnostic software, as well as learn and understand how the software is used.

Therefore, a simple, widely applicable, and user-friendly health status assessment method for bearings is desired.

### SUMMARY

Embodiments of the present disclosure provide a method of health assessment for a bearing, the method comprising: receiving multi-modal data with respect to the bearing and prompt information related to the content of the health assessment of the bearing; performing feature extraction on the multi-modal data using a first group of agents to generate a set of features regarding the multi-modal data; performing a health assessment of the bearing based on the set of features regarding the multi-modal data and the prompt information using a second group of agents to generate a plurality of health assessment results regarding the bearing; processing the plurality of health assessments using a third group of agents to generate a health assessment report regarding the bearing.

The method in accordance with at least one embodiment of the present disclosure, wherein the multimodal data comprises one or more of an image, a document, a sensor signal.

The method in accordance with at least one embodiment of the present disclosure, wherein the first group of agents includes one or more of an image information extraction agent, a sensor signal information extraction agent, and a document information extraction agent.

The method in accordance with at least one embodiment of the present disclosure, wherein the second group of agents includes one or more of a health management agent, a fault diagnosis agent, and a equipment maintenance agent, wherein the health management agent is configured to generate a remaining life of the bearing based on the features of the multimodal data and prompt information, the fault diagnosis agent is configured to generate a fault diagnosis result of the bearing based on the features of the multimodal data and prompt information, the equipment maintenance agent is configured to generate a maintenance recommendation for the bearing based on the features of the multimodal data and prompt information.

The method in accordance with at least one embodiment of the present disclosure, wherein the equipment maintenance agent is further configured to generate the maintenance recommendation for the bearing using at least one of the remaining life of the bearing and the fault diagnosis result based on the set of features regarding the multimodal data and the prompt information.

The method in accordance with at least one embodiment of the present disclosure, further comprising receiving one or more of the set of features on the multimodal data, a remaining life of the bearing, a failure detection result for the bearing, and a maintenance recommendation for the bearing directly from an external trusted system.

The method in accordance with at least one embodiment of the present disclosure, wherein each of the agents of the first group of agents, the second group of agents, and the third group of agents is configured to: determining a reasoning task related to a health status assessment of a bearing based on the prompt information; decomposing the reasoning task into a plurality of sub-reasoning tasks; and generating actions for each of a plurality of sub-reasoning tasks and performing the actions to determine a result for each sub-reasoning task to obtain a result for the reasoning task, wherein generating actions for each of the plurality of sub-reasoning tasks includes generating actions for each of the plurality of sub-reasoning tasks based on results of previous sub-reasoning tasks using one or more of memories, tools, and multi-agent collaboration.

The method in accordance with at least one embodiment of the present disclosure, wherein the memory comprises long term memory and short term memory, wherein the long term memory comprises a knowledge base for the reasoning task; and the short-term memory includes dialogue history in each round of human-computer dialogue.

The method in accordance with at least one embodiment of the present disclosure, wherein the tool comprises one or more of: calling a function for health status assessment of a bearing; an external database; web search; and drawing and reporting tools.

The method in accordance with at least one embodiment of the present disclosure, wherein each of the agents of the first group of agents, the second group of agents, and the third group of agents is configured to: improving the reasoning strategy of each agent based on the received scores and suggestions for the health assessment report about the bearing.

The health status assessment method, non-transitory computer-readable storage medium, and equipment for a bearing according to embodiments of the present disclosure can perform bearing health status assessment by allowing users to input multi-modal data, thereby improving the bearing health status assessment method flexibility. In addition, the health status assessment method of the bearing according to the present disclosure can better understand the user's problems with the help of the reasoning ability of the large language model, thereby providing better output such as maintenance recommendations.

### BRIEF DESCRIPTION OF DRAWINGS

The above and other aspects, features and advantages of specific embodiments of the present disclosure will become more apparent from the following description taken in conjunction with the accompanying drawings, in which:

FIG. 1 is a flowchart of a health assessment method for a bearing according to an embodiment of the present disclosure.

FIG. 2 is a schematic diagram of the architecture of an agent set according to an embodiment of the present disclosure.

FIG. 3 is a schematic diagram of a planning process for the agent set in accordance with an embodiment of the present disclosure.

FIG. 4 is a schematic diagram of a multi-agent collaboration process according to an embodiment of the present disclosure.

FIG. 5 is a schematic diagram of a specific implementation of multi-agent collaboration according to an embodiment of the present disclosure.

FIG. 6 is a schematic diagram of a health status assessment equipment for a bearing according to an embodiment of the present disclosure.

FIG. 7 is a non-transitory computer-readable storage medium in accordance with at least one embodiment of the present disclosure.

### DETAILED DESCRIPTION

Before proceeding to the following detailed description, it may be beneficial to set forth the definitions of certain words and phrases used throughout this patent application document. The terms “including” and “containing” and their derivatives refer to including but not limited to. The term “controller” or “control unit” refers to any device, system or part thereof that controls at least one operation. Such a controller may be implemented in hardware or a combination of hardware and software and/or firmware. The functions associated with any particular controller can be centralized or distributed, whether local or remote. The phrase “at least one”, when used with a list of items, means that different combinations of one or more of the listed items can be used, and only one item in the list may be needed. For example, “at least one of a, b and c” includes any one of the following combinations: a, b, c, a and b, a and c, b and c, a and b and c.

Definitions of other specific words and phrases are provided throughout this patent application document. It should be understood by those skilled in the art that in many cases, if not most cases, this definition also applies to the previous and future uses of words and phrases so defined.

The following description of various embodiments of the principles of the present disclosure in this patent application document with reference to the accompanying drawings is for illustration only and should not be interpreted as limiting the scope of the present disclosure in any way. Those skilled in the art will understand that the principles of the present disclosure can be implemented in any suitably arranged system or device. In some cases, the actions described in the specification can be performed in a different order and still achieve the desired results. Moreover, the processes depicted in the drawings do not necessarily require the specific order shown or sequential order to achieve the desired results. In certain embodiments, multitasking and parallel processing may be advantageous.

After a bearing has been used for a period of time, aging may occur. There may be a problem of cost prohibitions for the health assessment of bearings by hand. Health assessment of bearings by bearing diagnostic software may suffer from the problem that the bearing diagnostic software program have high requirements of format of input data and a single type of diagnostic results and maintenance recommendations for the bearing. Additionally, users may not be familiar with the bearing diagnosis software program. Before using the bearing diagnostic software program, the user may need to prepare the specific types of input data required by the bearing diagnostic software, as well as learn and understand how the software is used. In other words, the existing bearing diagnosis methods can not fully understand the needs of users, and can not provide answers that users need and are easy to understand.

Therefore, there is a desire for a bearing health status assessment method that can generate clear, accurate, and easy-to-understand answers about the health status of the bearing based on the user's questions (for example, prompt information) and data.

The present disclosure provides a health assessment method for a bearing, comprising: receiving multi-modal data about the bearing and prompt information; performing feature extraction on the multi-modal data using the first group of agents to generate a set of features on the multi-modal data; using a second group of agents to perform a health assessment on the bearing based on the set of features and the prompt information regarding the multi-modal data to generate a plurality of health assessment results regarding the bearing; combining the plurality of health assessment results using a third group of agents to generate a health assessment report regarding the bearing. The health assessment method of the bearing according to the embodiment of the present disclosure can output the health assessment report of the bearing based on data of various modalities input by the user and prompt information. This method has low data format requirements and reduces the difficulty for users. Furthermore, the method can provide a clear, intuitive, accurate, easy-to-understand health status assessment report on the health status of the bearing.

The health assessment method of the bearing of the present disclosure may be based on a Large Language Model (LLM). Large language models are language models in the field of NLP that are trained on large amounts of language corpus using autoregressive training for analysis and processing of language texts, which are intended to understand and generate human language. Large language models are trained on large amounts of text data and can perform a wide range of tasks, including text summarization, translation, sentiment analysis, etc. Large language models are characterized by their enormous size, which can contain billions of parameters to help them learn complex patterns in language text data. Therefore, in the bearing health assessment method of the present disclosure, the trained large language model can be applied to mutual information processing in the bearing health assessment method to provide efficient and accurate bearing health assessment services, thereby improving user experience. Traditional information retrieval models or bearing diagnosis software programs are usually based on keyword matching and indexing techniques. The limitation of this method is the inability to understand the semantic information and context. Large language models can understand the deep semantic information of text and better match the user's query intention, thereby improving the accuracy and efficiency of information query.

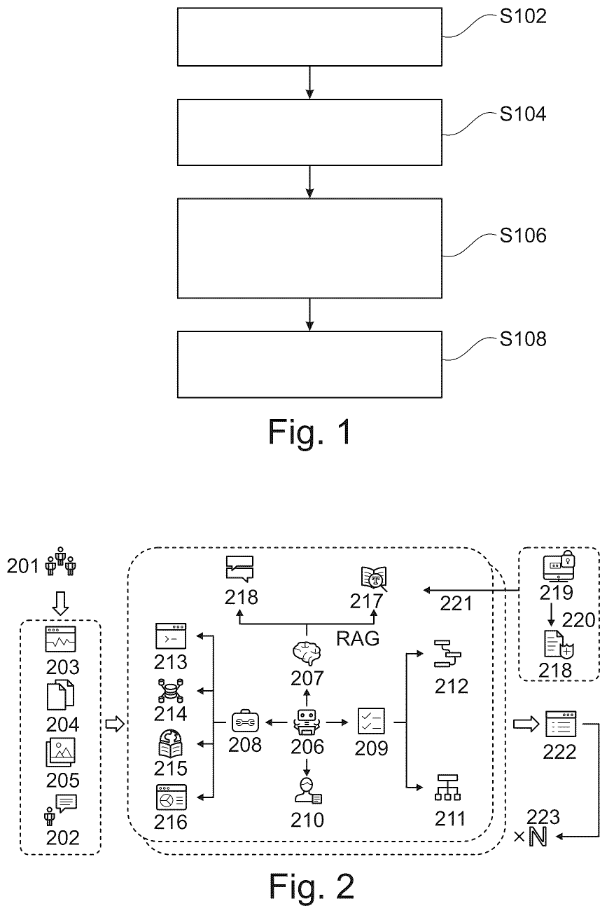

FIG. 1 is a flowchart of a health status assessment method for a bearing according to an embodiment of the present disclosure.

As shown in FIG. 1, the health status assessment method for a bearing may include steps S102, S104, S106, and S108.

In step S102, multi-modal data about the bearing and prompt information related to the health status assessment content of the bearing may be received. According to an embodiment of the present disclosure, the prompt information related to the health status assessment content of the bearing may be a log text input by a user or a device including the bearing. The prompt information related to the health status assessment content of the bearing may be plain text content formed in natural language. The prompt information related to the health status assessment content of the bearing may indicate a diagnostic report about the bearing that the user desires to obtain. For example, the prompt information may include natural language text such as “Please output a fault diagnosis report and maintenance recommendations based on photos of damaged bearings.”

According to embodiments of the present disclosure, multimodal data about the bearing may include images, videos, audio, documents, sensor signals, etc. For example, the image may include an image of the bearing or an equipment including the bearing captured by the user using an electronic device such as a cell phone. The video and audio may include video and audio captured by a user using the electronic device of a bearing while the bear is operating or of an equipment including the bearing while the equipment is operating. The documentation may include operating manuals about the bearing or equipment including the bearing. Sensor signals may include signals captured by sensors mounted to the bearing or equipment including the bearing or internal signals of the equipment including the bearing. Sensor signals may include, but are not limited to, sensor signals about the bearing captured by vibration sensors, temperature sensors, oil sensors, grease sensors, speed sensors, acoustic sensors. Sensor signals can be digital or analog.

At step S104, feature extraction may be performed on the multimodal data using the first group of agents to generate a set of features regarding the multimodal data. The first group of agents includes one or more of an image information extraction agent, a sensor signal information extraction agent, a document information extraction agent, and a text information extraction agent. The first group of agents may perform feature extraction on multi-modal data based on or not based on the above prompt information. For example, for images in multi-modal data about bearings, the image information extraction agent can extract their color features, texture features, shape features, spatial relationship features, etc., but the present disclosure is not limited thereto. For the temperature sensor signal, the sensor signal information extraction agent can extract its temperature change rate, peak-to-peak value and other features, but the present disclosure is not limited thereto. For the vibration sensor signal, the sensor signal information extraction agent can extract its vibration total value, vibration spectrum, peak-to-peak value and other features, but the present disclosure is not limited thereto. For documents, the document information extraction agent can extract features such as tables, pictures, text, and data contained therein, but the present disclosure is not limited thereto.

In step S106, a second group of agents may be used to perform a health assessment on the bearing based on the set of features regarding the multi-modal data and prompt information to generate a plurality of health assessment results regarding the bearing. For example, the second group of agents includes one or more of a health management agent, a fault diagnosis agent, and a device maintenance agent. The health management agent may output the remaining life of the bearing or the equipment including the bearing based on the set of features of the multimodal data and prompt information. The fault diagnosis agent may output fault diagnosis results of the bearing or equipment including the bearing based on the set of features of the multi-modal data and prompt information. In one embodiment according to the present disclosure, the fault diagnosis result may include a fault diagnosis result for a bearing or equipment in which a fault affecting operation has occurred. In another embodiment according to the present disclosure, the fault diagnosis result may include a fault prediction result for a potential defect that has not affected the operation of the bearing or equipment. The equipment maintenance agent can output maintenance recommendations for bearings or equipment including bearings based on the set of features of multi-modal data, fault diagnosis results, estimated remaining equipment life, and prompt information.

At step S108, the multiple health assessment results may be combined using a third group of agents to generate a health assessment report on the bearing. According to at least one embodiment of the present disclosure, the third group of agents may combine a plurality of health assessment results generated by the second group of agents into a report and generate a corresponding graph.

The first group of agents, the second group of agents, and the third group of agents may be LLM-based agents. For example, a first group of agents, a second group of agents, and a third group of agents may have LLM as the core computing engine. By virtue of the linguistic capabilities of LLM, methods according to the present disclosure can fully understand queries communicated by users and output clear, accurate, intuitive answers. Each agent of the first group of agents, the second group of agents, and the third group of agents can be responsible for different types of tasks, fine-tune on different downstream datasets, and can access different knowledge bases, call different functions, etc.

Methods according to embodiments of the present disclosure may reduce the format requirements of users for input data, thereby being suitable for more users and improving the user experience.

FIG. 2 is a schematic diagram of the architecture of an agent set according to an embodiment of the present disclosure.

As shown in FIG. 2, a user 201 may input prompt information 202 and multimodal data including sensor signals 203, documents 204, and images 205 to the agent set including a first group of agents, a second group of agents, and a third group of agents. Each agent in the agent set may perform reasoning tasks each related to the assessment of the health status of the bearing by using one or more of memory 207, tools 208, planning 209, and actions 210.

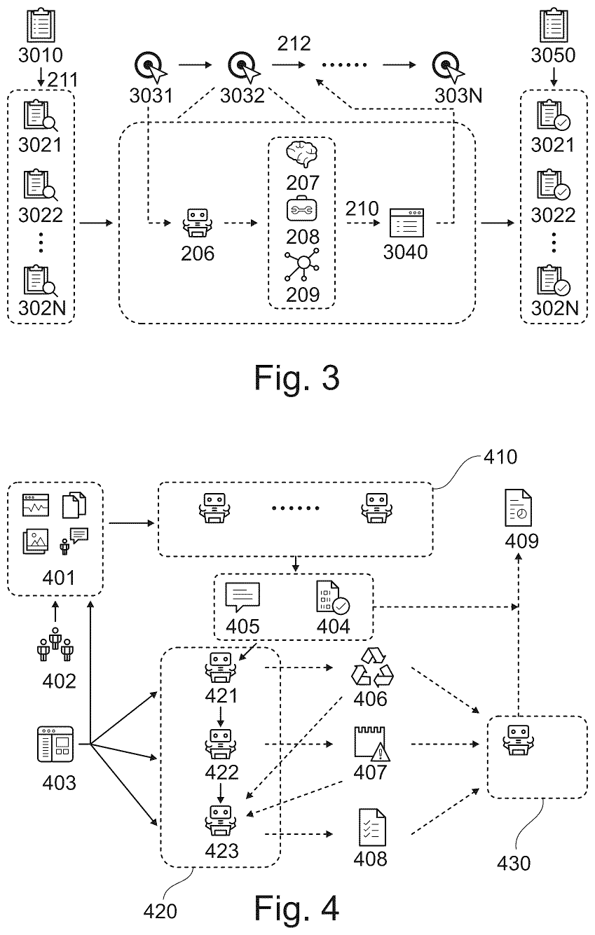

According to one embodiment of the present disclosure, the agents in the agent set may perform planning 209 when performing reasoning tasks related to the health status assessment of the bearing. Planning 209 can refer to decomposing (211) the reasoning task into reasoning subtasks and generating a reasoning chain (212) based on the reasoning subtasks. The entire reasoning task is completed by completing each reasoning subtask one by one by generating corresponding actions 210 based on the reasoning chain. Regarding the specific process of planning 209, it will be described in detail below with reference to FIG. 3.

According to one embodiment of the present disclosure, agents in the agent set may use tools 208 to perform reasoning tasks or reasoning subtasks related to the health status assessment of the bearing. In one embodiment, the agent may call a developed function (213). For example, there may be developed algorithms or functions for feature extraction for some reasoning tasks (e.g., for some data in multi-modal data). When the agent needs to perform such feature extraction, the agent can directly call the developed algorithms or functions described above to obtain accurate feature extraction results. Additionally, external databases 214 may be accessed for the agent in response to user inquiries about some health status. The external database 214 may include bearing specific parameter settings, etc. In one embodiment, the agent may perform a web page search 215 to obtain data not found in the database, knowledge base, or to respond to a user's query in combination with the results of the web page search and data in the knowledge base and database. In one embodiment, the agent can use drawing and reporting tools 216 to assemble textual content into reports and draw charts accordingly to more intuitively convey the bearing health status to the user.

According to one embodiment of the present disclosure, the agents in the agent set may use two types of memories, namely long-term memory and short-term memory, when performing reasoning tasks or reasoning subtasks related to the assessment of the health status of the bearing. Long-term memory refers to a previously stored, integrated knowledge base 217. For example, the knowledge base may include proprietary technical documents that the enterprise has historically accumulated, as well as information or knowledge previously learned by the agents in the agent set. This information or knowledge may be stored in a structured database, knowledge graph, or document storage, and queried according to the needs of the agents. For example, the content in the knowledge base may be stored primarily in the form of documents. According to embodiments of the present disclosure, access to the knowledge base by the group of agents of the user requires an authentication process to be performed (for example, access control 221). For example, only agent set of specific user (e.g., registered users as well as other specifically identified users) can access the knowledge base 217 or high security content in the knowledge base 217, thereby achieving the protection 220 of data security 218. The short-term memory may include the dialogue content of dialogue history of the user's conversation with the agent set for each turn. Agents may use long-term memory and short-term memory through Retrieval Augmented Generation techniques. The content in the knowledge base 217 may be segmented into blocks of text of a predetermined length to facilitate query and retrieval by the agent.

In this way, the agent set may generate clear, accurate, intuitive answers 222 to the user's queries about the health status of the bearings. In addition, the agent set may perform self-learning evolution 223. For example, the agent set may receive ratings or suggestions to the answers of the agent set by higher-level agents or humans (e.g., users), such as health assessment reports on bearings. The agent set can improve the reasoning strategy of each agent based on the score. For example, the group of agents can use reinforcement learning techniques to improve the reasoning strategy of each agent based on the scores.

FIG. 3 is a schematic diagram of a planning process for the agent set in accordance with an embodiment of the present disclosure.

As shown in FIG. 3, for a reasoning task 3010 related to the assessment of the health status of the bearing, the agents in the agent set 206 may decompose 211 the reasoning task 3010 into multiple subtasks (for example, subtasks 3021-302N) to prevent incomplete understanding and answering of user's questions or queries and to improve the performance of the agent in processing reasoning tasks 3010. The agent may generate a reasoning chain 212 including multiple reasoning steps (e.g., steps 3031-303N) based on multiple subtasks. By completing 3050 each subtask one by one, the entire reasoning task is finally completed.

Specifically, the results of previously completed reasoning steps will be used as input to subsequently performed reasoning steps to affect the output of subsequently performed reasoning steps. When performing each step, the agent may use one or more of the memory 207 and tools 208 described above to produce actions 210, thereby generating the reasoning results 3040 for each step. In addition, in performing each step, the agent may perform a multi-agent collaboration process 209. That is, the results produced by an agent in one reasoning step may be used as input to another agent's reasoning step, in addition to being used as input to that agent's subsequent reasoning step. The agent may complete 3050 the entire reasoning task by completing each reasoning step in the reasoning chain for subtasks one by one.

FIG. 4 is a schematic diagram of a multi-agent collaboration process according to an embodiment of the present disclosure. The solid lines in FIG. 4 represent the flow of data, and the dashed lines represent the flow of results produced by the agents. The data stream can represent content that flows within the agent set without presentation to the user 402, and the result stream can represent content that can be presented to the user 402.

As shown in FIG. 4, the first group of agents 410 can extract the set of features and prompt information based on the multi-modal data input by the user 402. As mentioned above, the first group of agents 410 may include one or more of the above-mentioned image information extraction agents, sensor signal information extraction agents, document information extraction agents, and text information extraction agents. The first group of agents 410 can provide the extracted set of features and prompt information to the second group of agents 420.

The second group of agents 420 may include one or more of the health management agent 421, fault diagnosis agent 422, and equipment maintenance agent 423 described above. As shown in FIG. 4, the health management agent 421 may generate the remaining life 406 of the bearing based on the prompt information and set of features. The fault diagnosis agent 422 may generate fault diagnosis results 407 based on prompt information and set of features. The equipment maintenance agent 423 may receive the remaining life 406 generated by the health management agent 421 and the fault diagnosis results 407 generated by the fault diagnosis agent 422. The equipment maintenance agent 423 may generate maintenance recommendations 408 for the bearing based on the set of features and prompt information using at least one of the remaining life 406 of the bearing and the fault diagnosis results 407. The second group of agents 420 may transmit the generated remaining life 406, fault diagnosis results 407, and maintenance recommendations 408 to the third group of agents 430.

The third group of agents 430 can combine the remaining life 406, fault diagnosis results 407, and maintenance recommendations 408 generated by the second group of agents 420 to generate a comprehensive report 409. In addition, the third group of agents 430 can generate corresponding charts based on the remaining life 406, fault diagnosis results 407, and maintenance recommendations 408 generated by the second group of agents 420, thereby more intuitively showing the health status of the bearing to the user 402.

Further, one or more of a set of features on the multimodal data, prompt information, remaining life of the bearing, fault detection results of the bearing, and maintenance recommendations of the bearing may be received directly from an external trusted system. For example, the agent set can receive one or more of the above data or results directly from an external trusted system, thereby reducing the reasoning process performed within the group of agents. External trusted systems may include bearing-mounted equipments, or other systems that are authorized.

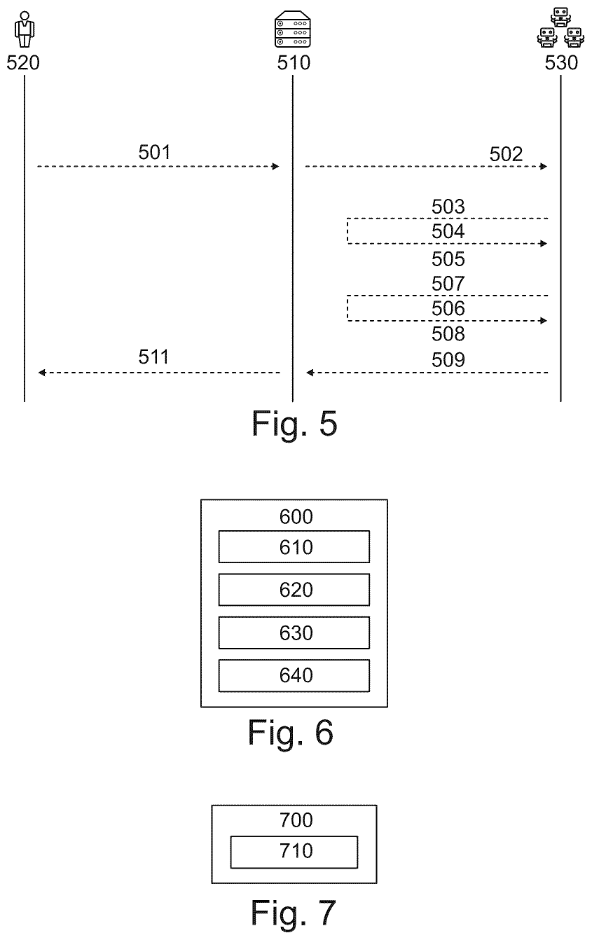

FIG. 5 is a schematic diagram of a specific implementation of multi-agent collaboration according to an embodiment of the present disclosure.

As shown in FIG. 5, a health assessment system for a bearing 510 may receive multimodal data including images, vibration signals, documents, and text from a user 520. The image may include an image of the equipment, such as an image of a damaged bearing. The vibration signal may include a vibration signal before the bearing is damaged. The documentation may include an equipment manual for the bearing. The text may include the content “Output fault reports and maintenance recommendations based on a photo of the damaged bearing and its vibration signal the day before the damage and its parameter table.” The above description of multimodal data is only an example, and the present disclosure is not limited thereto.

Agent-1 to agent-3 502 in the agent set 530 of the health assessment system 510 for bearings can call functions A, B and C respectively and process images, vibration signals and documents respectively to generate feature sets. Agent-1 to agent-3 can send feature sets and prompt information 503 to agent-4 to agent-6. Agent-1 to agent-3 may correspond to the first group of agents. Agent-4 504, Agent-5 505, and Agent-6 506 can respectively perform the reasoning process on the feature set and the prompt information as described with reference to FIG. 4, so as to generate the fault diagnosis result 506, remaining life 507, and equipment maintenance suggestion 508. Agent-4 to agent-6 may correspond to the second group of agents. Agent-7 509 can integrate or combine fault diagnosis results, remaining life, equipment maintenance suggestions, feature sets and prompt information to generate a final report.

Agent-7 may output to the user 520 a report 511 that includes the following: “Fault diagnosis result: the inner ring is broken perpendicular to the rotating shaft. The bearing inner race track shows excessive wear and peeling along the “load area”. The outer ring and rotor of the track show wear and particle indentation. Maintenance suggestion: check the seal to reduce the possibility of particle and moisture pollution; Check the lubricant type, lubricant amount and lubricant replenishment interval; Check the bearing fit to ensure that all matched parts are within the tolerance range; Ensure that grease is well stored to reduce the risk of source pollution”. Although no graph is shown in the report in FIG. 5, a report according to an embodiment of the present disclosure may include a graph associated with the health status of the bearing. For example, the report generated by Agent-7 can include a time domain/frequency domain spectrum of the vibration signal, a graph comparing the current remaining life with the total life, a graph comparing the current degree of failure with the degree of complete damage due to failure, etc., so as to convey the health status of the bearing more intuitively to the user 520.

FIG. 6 is a schematic diagram of a health status assessment device for a bearing according to an embodiment of the present disclosure.

As shown in FIG. 6, the health status assessment equipment 600 for a bearing may include a data receiving module 610, a first agent module 620, a second agent module 630, and a third agent module 640.

The data receiving module 610 may be configured to receive multimodal data about the bearing and prompt information related to the health status assessment content of the bearing.

The first agent module 620 can be configured to perform feature extraction on the multimodal data using the first group of agents to generate a set of features on the multimodal data.

The second agent module 630 can be configured to perform a health assessment on the bearing based on the set of features and prompt information regarding the multi-modal data using a second group of agents to generate a plurality of health assessment results regarding the bearing.

The third agent module 640 can be configured to combine the plurality of health assessment results using a third group of agents to generate a health assessment report regarding the bearing.

FIG. 7 is a non-transitory computer-readable storage medium in accordance with at least one embodiment of the present disclosure.

As shown in FIG. 7, non-transitory computer-readable storage medium 700 has computer instructions 710 stored thereon that, when executed by a processor, perform one or more steps of the various methods and additional aspects thereof as described above.

For example, the non-transitory computer-readable storage medium 700 may be any combination of one or more computer-readable storage media. For example, a computer-readable storage medium contains program codes for executing the various methods described above.

Exemplarily, when the program code is read by a computer, the computer can execute the program code stored in the computer storage medium and execute it to implement, for example, one or more steps of the above various methods and additional aspects thereof according to at least one embodiment of the present disclosure.

Illustratively, the non-transitory computer-readable storage medium may include a memory card of a smart phone, a storage component of a tablet computer, a hard disk of a personal computer, a random access memory (RAM), a read-only memory (ROM), an erasable programmable read-only memory (EPROM), a portable compact disc read-only memory (CD-ROM), flash memory, and other non-transitory readable storage media, or any combination thereof.

The health status assessment method, non-transitory computer-readable storage medium, and equipment for a bearing according to embodiments of the present disclosure can perform bearing health status assessment by allowing users to input multi-modal data, thereby improving the bearing health status assessment method flexibility. In addition, the health status assessment method of the bearing according to the present disclosure can better understand the user's problems with the help of the reasoning ability of the large language model, thereby providing better output such as maintenance recommendations.

The text and drawings are provided as examples only to assist in understanding the present disclosure. They should not be construed as limiting the scope of the disclosure in any way. Although certain embodiments and examples have been provided, it will be apparent to those skilled in the art, based upon this disclosure, that changes can be made to the embodiments and examples shown without departing from the scope of the disclosure.

Although the present disclosure has been described with an exemplary embodiment, various changes and modifications may be suggested to one skilled in the art. It is intended that the present disclosure encompass such changes and modifications as fall within the scope of the appended claims.

None of the description in the present disclosure should be read as implying that any particular element, step, or function is an essential element that must be included in the claim scope. The scope of patented subject matter is defined only by the claims.

What is claimed is:

1. A method of health assessment for a bearing, the method comprising:
receiving multi-modal data with respect to the bearing and prompt information related to the content of the health assessment of the bearing;
performing feature extraction on the multi-modal data using a first group of agents to generate a set of features regarding the multi-modal data;
performing a health assessment of the bearing based on the set of features regarding the multi-modal data and the prompt information using a second group of agents to generate a plurality of health assessment results regarding the bearing;
processing the plurality of health assessments using a third group of agents to generate a health assessment report regarding the bearing.

2. The method of claim 1, wherein the multimodal data comprises one or more of an image, a document, a sensor signal.

3. The method of claim 1, wherein the first group of agents includes one or more of an image information extraction agent, a sensor signal information extraction agent, and a document information extraction agent.

4. The method of claim 1, wherein the second group of agents includes one or more of a health management agent, a fault diagnosis agent, and a equipment maintenance agent, wherein:
the health management agent is configured to generate a remaining life of the bearing based on the features of the multimodal data and prompt information;
the fault diagnosis agent is configured to generate a fault diagnosis result of the bearing based on the features of the multimodal data and prompt information; and
the equipment maintenance agent is configured to generate a maintenance recommendation for the bearing based on the features of the multimodal data and prompt information.

5. The method of claim 4, wherein the equipment maintenance agent is further configured to generate the maintenance recommendation for the bearing using at least one of the remaining life of the bearing and the fault diagnosis result based on the set of features regarding the multimodal data and the prompt information.

6. The method of claim 4, further comprising receiving one or more of the set of features on the multimodal data, a remaining life of the bearing, a failure detection result for the bearing, and a maintenance recommendation for the bearing directly from an external trusted system.

7. The method of claim 1, wherein each of the agents of the first group of agents, the second group of agents, and the third group of agents:
determine a reasoning task related to a health status assessment of a bearing based on the prompt information;
decompose the reasoning task into a plurality of sub-reasoning tasks; and
generate actions for each of a plurality of sub-reasoning tasks and performing the actions to determine a result for each sub-reasoning task to obtain a result for the reasoning task, wherein said generating actions for each of the plurality of sub-reasoning tasks includes generating actions for each of the plurality of sub-reasoning tasks based on results of previous sub-reasoning tasks using one or more of memories, tools, and multi-agent collaboration.

8. The method of claim 7, wherein the memory comprises long term memory and short term memory, wherein:
the long term memory comprises a knowledge base for the reasoning task; and
the short-term memory includes dialogue history in each round of human-computer dialogue.

9. The method of claim 7, wherein the tool comprises one or more of:
calling a function for health status assessment of a bearing;
an external database;
web search; or
drawing and reporting tools.

10. The method of claim 1, wherein each of the agents of the first group of agents, the second group of agents, and the third group of agents improve the reasoning strategy of each agent based on the received scores and suggestions for the health assessment report about the bearing.
